(19) United States
(12) Patent Application Publication
(10) Pub. No.: US 2023/0237858 A1
(43) Pub. Date: Jul. 27, 2023

(54) VEHICLE MANAGEMENT DEVICE AND VEHICLE MANAGEMENT METHOD

(71) Applicant: TOYOTA JIDOSHA KABUSHIKI KAISHA, Toyota-shi (JP)

(72) Inventors: Ryosuke KOBAYASHI, Nagakute-shi (JP); Tomokazu MAYA, Nagoya-shi (JP); Tsuyoshi OKADA, Nagoya-shi (JP); Hiromitsu FUJII, Kariya-shi (JP)

(21) Appl. No.: 18/051,897

(22) Filed: Nov. 2, 2022

(30) Foreign Application Priority Data
Jan. 24, 2022 (JP) 2022-008530

(51) Int. Cl. G07C 5/08; G07C 5/02

(52) U.S. Cl. CPC G07C 5/0808; G07C 5/02

(57) ABSTRACT

A vehicle management device includes a first driving unit, a second driving unit, an inspection unit, and a maintenance unit. The first driving unit transmits a first signal for autonomously driving a first vehicle included in a vehicle group under a first condition. The second driving unit transmits a second signal for autonomously driving a second vehicle that is a vehicle other than the first vehicle included in the vehicle group under a second condition that the vehicle is less likely to be deteriorated than under the first condition. The inspection unit makes an instruction for a performance inspection of the first vehicle after autonomous driving of the first vehicle under the first condition ends. The maintenance unit decides a maintenance time of the second vehicle by using a result of the performance inspection of the first vehicle.

### CROSS-REFERENCE TO RELATED APPLICATION

This application claims priority to Japanese Patent Application No. 2022-008530 filed on Jan. 24, 2022, incorporated herein by reference in its entirety.

### BACKGROUND

### 1. Technical Field

The present disclosure relates to a vehicle management device and a vehicle management method.

### 2. Description of Related Art

Japanese Unexamined Patent Application Publication No. 2020-074169 (JP 2020-074169 A) discloses a vehicle system that allocates an autonomous driving vehicle.

### SUMMARY

It is considered that each autonomous driving vehicle allocated in the vehicle system described above is operated while undergoing a performance inspection on a regular basis. Moreover, in a case where any of various components mounted on the autonomous driving vehicle is evaluated to have insufficient performance in the performance inspection, it is considered that the component is replaced.

However, in a case where the number of autonomous driving vehicles managed by a business operator is large, there is a problem that the number of performance inspections is too large. In a case where the number of performance inspections is too large, there is probability that the vehicle management is complicated, large-scale inspection equipment is needed, and an inspection cost is increased.

The present disclosure is to reduce the total number of performance inspections of each managed autonomous driving vehicle in a system that manages a plurality of autonomous driving vehicles.

A first aspect of the present disclosure relates to a vehicle management device includes a first driving unit, a second driving unit, an inspection unit, and a maintenance unit. The first driving unit is configured to transmit a first signal for autonomously driving a first vehicle included in a vehicle group under a first condition. The second driving unit is configured to transmit a second signal for autonomously driving a second vehicle that is a vehicle other than the first vehicle included in the vehicle group under a second condition that the vehicle is less likely to be deteriorated than under the first condition. The inspection unit is configured to make an instruction for a performance inspection of the first vehicle after autonomous driving of the first vehicle under the first condition ends. The maintenance unit is configured to decide a maintenance time of the second vehicle by using a result of the performance inspection of the first vehicle.

In the configuration described above, the performance inspection is executed with respect to the first vehicle. The performance inspection may be an inspection corresponding to a so-called vehicle inspection. A component for which a performance abnormality (performance degradation exceeding an allowable level) has been checked by the performance inspection may be replaced with a new component. It should be noted that the performance abnormality also includes a state in which a degree of deterioration of the component is larger than a predetermined level, in addition to a component failure.

In the configuration described above, the maintenance time of the second vehicle is decided by using the result of the performance inspection of the first vehicle. The performance inspection of the first vehicle is executed after the first vehicle is autonomously driven under the condition (first condition) that the vehicle is more likely to be deteriorated than a driving condition (second condition) of the second vehicle. Therefore, in a case where the performance of the first vehicle is determined to be normal by the performance inspection of the first vehicle, it can be estimated that the performance of the second vehicle is also normal. That is, in a case where the performance of the first vehicle is determined to be normal by the performance inspection of the first vehicle, the performance inspection of the second vehicle can be omitted. With the configuration described above, in a system that manages the autonomous driving vehicles, it is possible to reduce the total number of performance inspections of each managed autonomous driving vehicle.

The vehicle management device may be composed of one computer or may include a plurality of computers. The first driving unit and the second driving unit may transmit the first signal and the second signal to the first vehicle and the second vehicle, respectively. Alternatively, in a system including a server that controls autonomous driving of each vehicle included in the vehicle group (hereinafter, also referred to as “driving control server”), the first signal and the second signal may be transmitted from the first driving unit and the second driving unit to the driving control server. The inspection unit may instruct the first vehicle of which autonomous driving under the first condition ends to undergo the performance inspection. Alternatively, the inspection unit may instruct the driving control server to direct the first vehicle of which autonomous driving under the first condition ends to an inspection place. The maintenance unit may transmit a signal (hereinafter, also referred to as “maintenance signal”) for requesting the maintenance of the component. The maintenance unit may request the maintenance to a predetermined company. Examples of the maintenance include inspection, repair, and replacement. The maintenance unit may transmit the maintenance signal for requesting replacement of the component. The maintenance unit may transmit the maintenance signal to a terminal of a vehicle manager (for example, a mobile terminal carried by the vehicle manager). Alternatively, the maintenance unit may transmit the maintenance signal to the vehicle. The computer of the vehicle that receives the maintenance signal may execute processing of executing component maintenance requested by the maintenance signal (hereinafter, also referred to as “maintenance processing”). The maintenance processing may be processing of notifying the vehicle manager of the arrival of the maintenance time together with the component that is a target of the maintenance (for example, a name or a place of the component). Alternatively, the maintenance processing may be processing of requesting the maintenance.

The maintenance unit may be configured to determine whether or not to execute maintenance of the second vehicle by using the result of the performance inspection of the first vehicle after autonomous driving of the second vehicle under the second condition ends. With such a configuration, it is easy to appropriately decide a time of executing the maintenance of the second vehicle. For example, the component maintenance of the second vehicle may be executed for the component corresponding to the component for which the abnormality has been checked in the first vehicle.

A traveling route of autonomous driving may be the same in the first condition and the second condition.

Each vehicle that travels on the same route by autonomous driving is more likely to be deteriorated in the same part. It should be noted that, by changing a condition other than the traveling route, it is possible to make a progress degree of deterioration due to autonomous driving different between the first vehicle and the second vehicle. With the configuration described above, the progress degree of deterioration of the first vehicle and the progress degree of deterioration of the second vehicle are more likely to correlate with each other. Therefore, it is easy to appropriately evaluate the performance of the second vehicle by using the result of the performance inspection of the first vehicle.

A traveling purpose of autonomous driving may be the same in the first condition and the second condition.

Each vehicle that executes autonomous driving for the same purpose is more likely to be deteriorated in the same part. For example, in a vehicle that executes autonomous driving for a mobile office use, an in-vehicle device is used during movement, so that the deterioration of a power storage device is more likely to progress. In addition, in a vehicle that executes autonomous driving for a passenger transportation use, the deterioration of a suspension is more likely to progress due to getting on and off of a person. By making the traveling purpose of autonomous driving the same in the first vehicle and the second vehicle, the progress degree of deterioration of the first vehicle and the progress degree of deterioration of the second vehicle are more likely to correlate with each other. Therefore, it is easy to appropriately evaluate the performance of the second vehicle by using the result of the performance inspection of the first vehicle.

At least one of a traveling distance, weight, and a vehicle speed in the first condition may be set such that the vehicle is more likely to be deteriorated than under the second condition.

With the configuration described above, it is easy to set the first condition that the vehicle is more likely to be deteriorated than under the second condition. As the traveling distance of the vehicle by autonomous driving is longer, the vehicle is more likely to be deteriorated. As the vehicle speed during autonomous driving is higher, the vehicle is more likely to be deteriorated. As the weight of the vehicle during autonomous driving is larger, the vehicle is more likely to be deteriorated. The weight described above may be the total weight obtained by adding the weight of the person who gets on the vehicle and the weight of an object loaded on the vehicle to the weight of a vehicle body. Alternatively, the weight may be the weight of the vehicle body solely. The weight of the vehicle may be estimated based on the number of occupants in the vehicle.

The result of the performance inspection of the first vehicle may include first data indicating performance of the first vehicle. The maintenance unit may be configured to execute an operation of converting the first data into second data indicating performance of the second vehicle and decide the maintenance time of the second vehicle based on the second data.

With the configuration described above, it is possible to acquire the second data indicating the performance of the second vehicle by the operation without executing the performance inspection of the second vehicle. The maintenance unit may convert the first data into the second data by using a predetermined conversion coefficient.

Any of the vehicle management devices described above may further include a determination unit configured to determine whether or not a requested autonomous driving condition corresponds to any of the first condition and the second condition. Moreover, the first driving unit may be configured to transmit the first signal in a case where the requested autonomous driving condition corresponds to the first condition. In addition, the second driving unit may be configured to transmit the second signal in a case where the requested autonomous driving condition corresponds to the second condition.

With the configuration described above, the first vehicle can be autonomously driven under the first condition in a case where the requested autonomous driving condition corresponds to the first condition, and the second vehicle can be autonomously driven under the second condition in a case where the requested autonomous driving condition corresponds to the second condition. Therefore, each of the first vehicle and the second vehicle can be appropriately operated in accordance with the requested autonomous driving condition.

A second aspect of the present disclosure relates to a vehicle management method including a first autonomous driving step, a second autonomous driving step, a performance inspection step, and a maintenance step.

In the first autonomous driving step, a first vehicle is autonomously driven under a first condition. In the second autonomous driving step, a second vehicle is autonomously driven under a second condition that a vehicle is less likely to be deteriorated than under the first condition. In the performance inspection step, a performance inspection of the first vehicle is executed after autonomous driving of the first vehicle under the first condition ends. In the maintenance step, maintenance of the second vehicle is executed in a case where a fail determination is made by the performance inspection of the first vehicle.

Similar to the vehicle management device described above, even with the vehicle management method described above, in the system that manages the autonomous driving vehicles, it is possible to reduce the total number of performance inspections of each managed autonomous driving vehicle.

A third aspect of the present disclosure relates to a vehicle management method including a first autonomous driving step, a second autonomous driving step, a performance inspection step, a conversion step, and a maintenance step.

In the first autonomous driving step, a first vehicle is autonomously driven under a first condition. In the second autonomous driving step, a second vehicle is autonomously driven under a second condition that a vehicle is less likely to be deteriorated than under the first condition. In the performance inspection step, a performance inspection of the first vehicle is executed to acquire first data indicating performance of the first vehicle after autonomous driving of the first vehicle under the first condition ends. In the conversion step, the first data is converted into second data indicating performance of the second vehicle. In the maintenance step, maintenance of the second vehicle is executed in a case where the second data indicates a performance fail of the second vehicle.

Similar to the vehicle management device described above, even with the vehicle management method described above, in the system that manages the autonomous driving vehicles, it is possible to reduce the total number of performance inspections of each managed autonomous driving vehicle.

According to the present disclosure, in the system that manages the autonomous driving vehicles, it is possible to reduce the total number of performance inspections of each managed autonomous driving vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle according to a first embodiment of the present disclosure;

FIG. 2 is a diagram showing details of the configuration of the vehicle shown in FIG. 1;

FIG. 3 is a flowchart showing processing procedure of autonomous driving control according to the first embodiment of the present disclosure;

FIG. 4 is a diagram for describing a configuration of a vehicle management device according to the first embodiment of the present disclosure;

FIG. 5 is a flowchart showing management processing executed by the vehicle management device for a representative vehicle in a vehicle management method according to the first embodiment of the present disclosure;

FIG. 6 is a flowchart showing management processing executed by the vehicle management device for a general vehicle in the vehicle management method according to the first embodiment of the present disclosure;

FIG. 7 is a diagram showing a configuration of a vehicle management device according to a second embodiment of the present disclosure;

FIG. 8 is a flowchart showing management processing executed by the vehicle management device for a representative vehicle in a vehicle management method according to the second embodiment of the present disclosure;

FIG. 9 is a flowchart showing management processing executed by the vehicle management device for a general vehicle in the vehicle management method according to the second embodiment of the present disclosure;

FIG. 10 is a diagram showing a configuration of a vehicle management device according to a third embodiment of the present disclosure; and

FIG. 11 is a flowchart showing management processing executed by the vehicle management device for a running vehicle in the vehicle management method according to the third embodiment of the present disclosure.

### DETAILED DESCRIPTION OF EMBODIMENTS

In the following, embodiments of the present disclosure will be described in detail with reference to the drawings. It should be noted that, in the drawings, the same or corresponding parts are designated by the same reference signs and the description thereof will not be repeated.

### First Embodiment

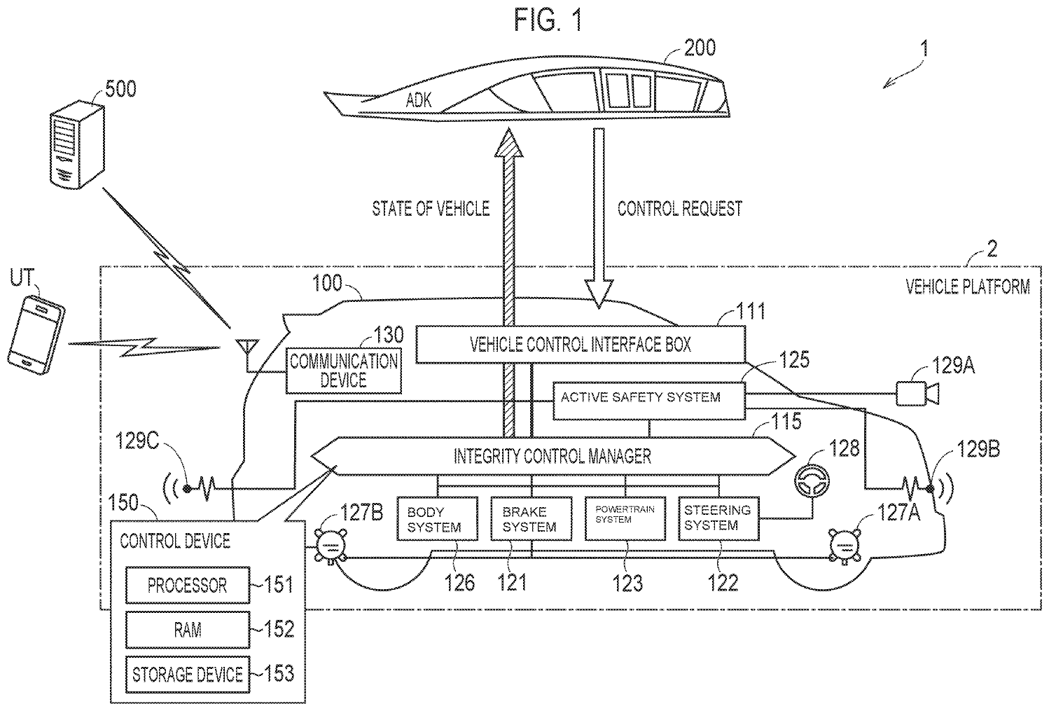

FIG. 1 is a diagram showing a schematic configuration of a vehicle according to the embodiment of the present disclosure. With reference to FIG. 1, a vehicle 1 includes an autonomous driving kit (hereinafter, referred to as “ADK”) 200 and a vehicle platform (hereinafter, referred to as “VP”) 2.

The VP 2 includes a control system of a base vehicle 100 and a vehicle control interface box (hereinafter, referred to as “VCIB”) 111 provided in the base vehicle 100. The VCIB 111 may communicate with the ADK 200 via an in-vehicle network, such as a controller area network (CAN). It should be noted that, although the base vehicle 100 and the ADK 200 are shown at separate positions in FIG. 1, the ADK 200 is actually attached to the base vehicle 100. In the present embodiment, the ADK 200 is attached to a rooftop of the base vehicle 100. It should be noted that an attachment position of the ADK 200 can be changed as appropriate.

The base vehicle 100 is, for example, a commercially available electrified vehicle (xEV). The xEV is a vehicle that uses electric power as all or part of a power source. In the present embodiment, a battery electric vehicle (BEV) is adopted as the base vehicle 100. It should be noted that the present disclosure is not limited to this, and the base vehicle 100 may be an xEV (HEV, PHEV, FCEV, or the like) other than the BEV. The number of wheels provided in the base vehicle 100 is, for example, four. It should be noted that the number of wheels provided in the base vehicle 100 is not limited to this, and may be three or five or more.

The control system of the base vehicle 100 includes, in addition to an integrity control manager 115, various systems and various sensors for controlling the base vehicle 100. The integrity control manager 115 controls various systems related to the operation of the base vehicle 100 in an integrated manner based on signals (sensor detection signals) from various sensors provided in the base vehicle 100.

In the present embodiment, the integrity control manager 115 includes a control device 150. The control device 150 includes a processor 151, a random access memory (RAM) 152, and a storage device 153. As the processor 151, for example, a central processing unit (CPU) can be adopted. The RAM 152 functions as a working memory that transitorily stores the data processed by the processor 151. The storage device 153 is configured to store the stored information. For example, the storage device 153 includes a read only memory (ROM) and a rewritable non-volatile memory. The storage device 153 stores information used in a program (for example, a map, a mathematical formula, and various parameters), in addition to the program. In the present embodiment, the processor 151 executes the program stored in the storage device 153 to execute various vehicle controls (for example, autonomous driving control in response to an instruction from the ADK 200). It should be noted that these pieces of processing may be executed by dedicated hardware (electronic circuit) instead of software. It should be noted that the number of processors provided in the control device 150 is optional, and the processor may be prepared for each predetermined control.

The base vehicle 100 includes a brake system 121, a steering system 122, a powertrain system 123, an active safety system 125, and a body system 126. These systems are controlled in an integrated manner by the integrity control manager 115. In the present embodiment, each system includes the computer. Moreover, the computer for each system communicates with the integrity control manager 115 via the in-vehicle network (for example, the CAN). In the following, the computer provided in each system is referred to as an “electronic control unit (ECU)”.

The brake system 121 includes a braking device provided in each wheel of the base vehicle 100, and an ECU that controls the braking device. In the present embodiment, a hydraulic disc brake device is adopted as the braking device. The base vehicle 100 includes wheel speed sensors 127A, 127B. The wheel speed sensors 127A are provided in front wheels of the base vehicle 100 and detect the rotation speed of the front wheels. The wheel speed sensors 127B are provided in rear wheels of the base vehicle 100 and detect the rotation speed of the rear wheels. The ECU of the brake system 121 outputs a rotation direction and the rotation speed of each wheel detected by the wheel speed sensors 127A, 127B to the integrity control manager 115.

The steering system 122 includes a steering device of the base vehicle 100, and an ECU that controls the steering device. The steering device includes, for example, a rack and pinion type electric power steering (EPS) in which a steering angle can be adjusted by an actuator. The base vehicle 100 includes a pinion angle sensor 128. The pinion angle sensor 128 detects a rotation angle (pinion angle) of a pinion gear coupled to a rotation shaft of the actuator constituting the steering device. The ECU of the steering system 122 outputs the pinion angle detected by the pinion angle sensor 128 to the integrity control manager 115.

The powertrain system 123 includes an electric parking brake (EPB) provided in at least one of the wheels provided in the base vehicle 100, a P-Lock device provided in a transmission of the base vehicle 100, a shift device configured to select a shift range, a drive source of the base vehicle 100, and an ECU that controls each device provided in the powertrain system 123. The EPB is provided separately from the braking device described above, and puts the wheels into a fixed state by an electric actuator. For example, the P-Lock device puts a rotation position of an output shaft of the transmission into the fixed state by a parking lock pole that can be driven by the actuator. Although details will be described below, in the present embodiment, a motor that receives electric power supplied from a power storage device is adopted as the drive source of the base vehicle 100. The ECU of the powertrain system 123 outputs, to the integrity control manager 115, the presence or absence of fixation by each of the EPB and the P-Lock device, the shift range selected by the shift device, and a state of each of the power storage device and the motor.

The active safety system 125 includes an ECU that determines the probability of collision with respect to the traveling vehicle 1. The base vehicle 100 includes a camera 129A and radar sensors 129B, 129C that detect peripheral situations including the front and rear of the vehicle 1. The ECU of the active safety system 125 determines whether or not there is the probability of collision by using the signals received from the camera 129A and the radar sensors 129B, 129C. In a case where the active safety system 125 determines that there is the probability of collision, the integrity control manager 115 outputs a braking command to the brake system 121 to increase a braking force of the vehicle 1. The base vehicle 100 according to the present embodiment includes the active safety system 125 from an initial stage (at the time of shipment). However, the present disclosure is not limited to this, and an active safety system that can be retrofitted to the base vehicle may be adopted.

The body system 126 includes body system components (for example, turn signals, a horn, and a windshield wiper), and an ECU that controls the body system components. The ECU of the body system 126 controls the body system components in response to a user operation in a manual mode, controls the body system components in response to the command received from the ADK 200 via the VCIB 111 and the integrity control manager 115 in an autonomous mode.

The vehicle 1 is configured to execute autonomous driving. The VCIB 111 functions as a vehicle control interface. In a case where the vehicle 1 travels by autonomous driving, the integrity control manager 115 and the ADK 200 exchange signals with each other via the VCIB 111, and the integrity control manager 115 executes traveling control (that is, autonomous driving control) by the autonomous mode in response to the command from the ADK 200. It should be noted that the ADK 200 can also be removed from the base vehicle 100. The base vehicle 100 can travel as a single base vehicle 100 by the user's driving even in a state in which the ADK 200 is removed. In a case where the base vehicle 100 travels as a single base vehicle 100, the control system of the base vehicle 100 executes the traveling control in the manual mode (that is, traveling control in response to the user operation).

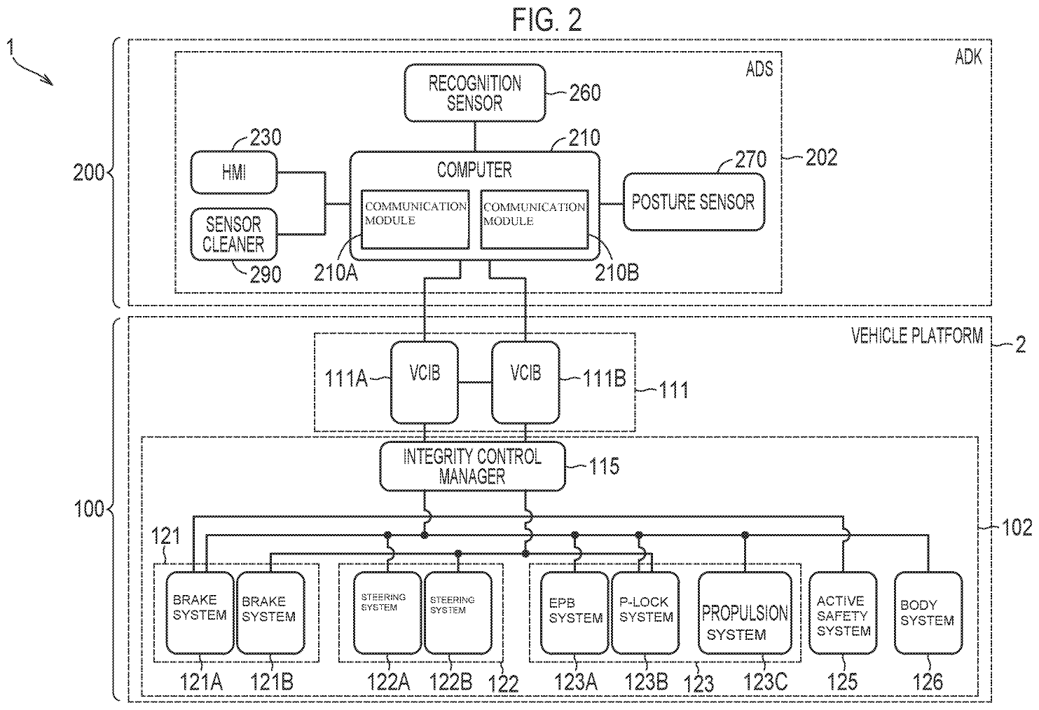

In the present embodiment, the ADK 200 exchanges signals with the VCIB 111 in accordance with an application program interface (API) that defines each signal to be communicated. The ADK 200 is configured to process various signals defined by the API described above. For example, the ADK 200 creates a traveling plan of the vehicle 1 and outputs various commands requesting control to cause the vehicle 1 to travel in accordance with the created traveling plan to the VCIB 111 in accordance with the API described above. In the following, each of the various commands described above output from the ADK 200 to the VCIB 111 is also referred to as an “API command”. In addition, the ADK 200 receives various signals indicating a state of the base vehicle 100 from the VCIB 111 in accordance with the API, and reflects the received state of the base vehicle 100 in the creation of the traveling plan. In the following, each of the various signals received by the ADK 200 from the VCIB 111 is also referred to as an “API signal”. Both the API command and the API signal correspond to the signals defined in the API described above. Details of the configuration of the ADK 200 will be described below (see FIG. 2).

The VCIB 111 receives various API commands from the ADK 200. In a case where the API command is received from the ADK 200, the VCIB 111 converts the API command into a signal format that can be processed by the integrity control manager 115. In the following, the API command converted into the signal format that can be processed by the integrity control manager 115 is also referred to as “control command”. In a case where the API command is received from the ADK 200, the VCIB 111 outputs the control command corresponding to the API command to the integrity control manager 115.

The control device 150 of the integrity control manager 115 transmits various signals (for example, a sensor signal or a status signal) indicating the state of the base vehicle 100 detected in the control system of the base vehicle 100 to the ADK 200 via the VCIB 111. The VCIB 111 sequentially receives the signals indicating the state of the base vehicle 100 from the integrity control manager 115. The VCIB 111 decides a value of the API signal based on the signals received from the integrity control manager 115. In addition, the VCIB 111 also converts the signal received from the integrity control manager 115 into an API signal format, as needed. Moreover, the VCIB 111 outputs the obtained API signal to the ADK 200. The API signal indicating the state of the base vehicle 100 is sequentially output from the VCIB 111 to the ADK 200 in real time.

In the present embodiment, a less versatile signal defined by, for example, an automobile manufacturer is exchanged between the integrity control manager 115 and the VCIB 111, and a more versatile signal (for example, a signal defined by an open API) is exchanged between the ADK 200 and the VCIB 111. The VCIB 111 converts the signals between the ADK 200 and the integrity control manager 115 to allow the integrity control manager 115 to execute the vehicle control in response to the command from the ADK 200. It should be noted that the function of the VCIB 111 is not limited to the function of converting the signals described above. For example, the VCIB 111 may make a predetermined determination and transmit signals based on the determination result (for example, signals for notification, instruction, and request) to at least one of the integrity control manager 115 and the ADK 200. Details of the configuration of the VCIB 111 will be described below (see FIG. 2).

The base vehicle 100 further includes a communication device 130. The communication device 130 includes various communication interfaces (I/Fs). The control device 150 is configured to execute communication with an external device of the vehicle 1 (for example, a mobile terminal UT and a server 500 described below) via the communication device 130. The communication device 130 includes a wireless communication device (for example, a data communication module (DCM)) that can access a mobile communication network (telematics). The communication device 130 communicates with the server 500 via the mobile communication network. The wireless communicator may include a communication I/F compatible with fifth-generation mobile communication system (5G). In addition, the communication device 130 includes a communication I/F for directly communicating with the mobile terminal UT present in the vehicle or in a range around the vehicle. The communication device 130 and the mobile terminal UT may execute short-range communication, such as wireless local area network (LAN), near field communication (NFC), or Bluetooth (registered trademark).

The mobile terminal UT is a terminal carried by the user of the vehicle 1. In the present embodiment, a smartphone equipped with a touch panel display is adopted as the mobile terminal UT. It should be noted that the present disclosure is not limited to this, any mobile terminal can be adopted as the mobile terminal UT, and a laptop, a tablet terminal, a wearable device (for example, a smartwatch or smart glasses), an electronic key, or the like can also be adopted.

The vehicle 1 can be adopted as one of the components of a mobility-as-a-service (MaaS) system. The MaaS system includes, for example, a mobility service platform (MSPF). The MSPF is a unified platform to which various mobility services (for example, various mobility services provided by a ride sharing business operator, a car sharing business operator, an insurance company, a car rental business operator, a taxi business operator, and the like) are connected. The server 500 is a computer that manages and opens information for the mobility services in the MSPF. The server 500 manages various types of mobility information, and provides information (for example, the API and information on cooperation between mobility) in response to a request from the business operator. The business operator that provides the service can use various functions provided by the MSPF by using the API open on the MSPF. For example, the API needed for the development of the ADK is open on the MSPF.

FIG. 2 is a diagram showing details of the configuration of the vehicle 1. With reference to FIG. 2 together with FIG. 1, the ADK 200 includes an autonomous driving system (hereinafter, referred to as “ADS”) 202 for executing autonomous driving of the vehicle 1. The ADS 202 includes a computer 210, a human machine interface (HMI) 230, a recognition sensor 260, a posture sensor 270, and a sensor cleaner 290.

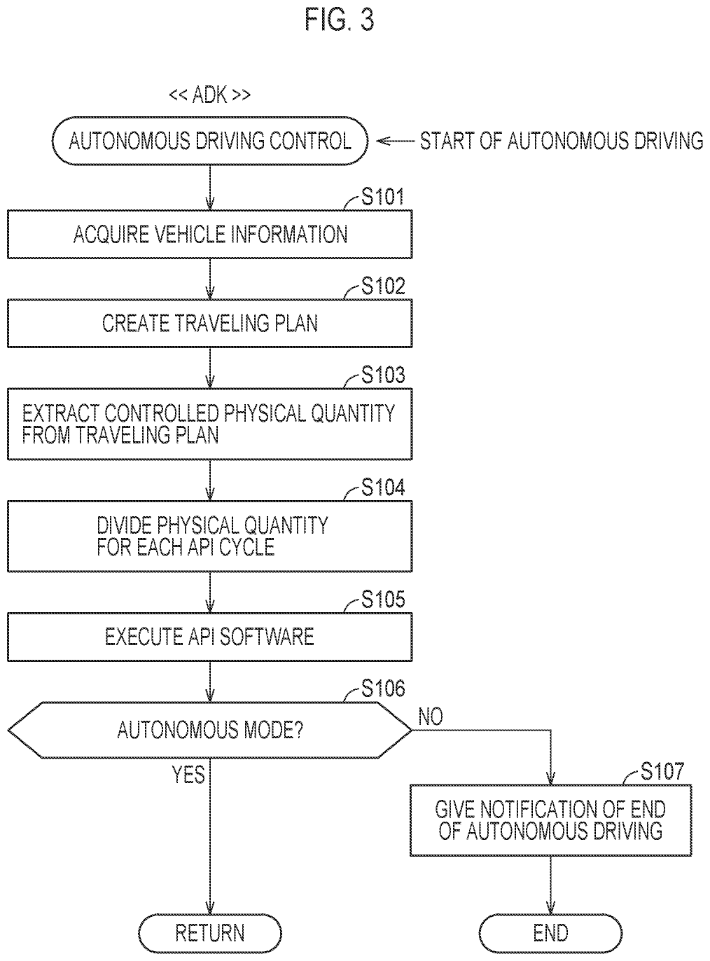

The computer 210 includes a processor and a storage device that stores autonomous driving software using the API, and is configured to execute the autonomous driving software by the processor. The autonomous driving software executes control related to autonomous driving (see FIG. 3 described below). The autonomous driving software may be updated sequentially by over the air (OTA). The computer 210 further includes communication modules 210A, 210B.

The HMI 230 is a device for exchanging information between the user and the computer 210. The HMI 230 includes an input device and a notification device. Through the HMI 230, the user can make an instruction or a request to the computer 210 or change a value of a parameter used in the autonomous driving software (it should be noted that the change is limited to a parameter that is allowed to be changed). The HMI 230 may be a touch panel display having both functions of the input device and the notification device.

The recognition sensor 260 includes various sensors that acquire information for recognizing an external environment of the vehicle 1 (hereinafter, also referred to as “environmental information”). The recognition sensor 260 acquires the environmental information of the vehicle 1 and outputs the acquired environmental information to the computer 210. The environmental information is used for the autonomous driving control. In the present embodiment, the recognition sensor 260 includes a camera that images the surroundings (including the front and rear) of the vehicle 1 and an obstacle detector (for example, a millimeter wave radar and/or a LiDAR) that detects an obstacle by electromagnetic waves or sound waves. For example, the computer 210 can recognize a person present in a range that can be recognized by the vehicle 1, an object (other vehicles, a pillar, a guardrail, or the like), and a line on a road (for example, a center line) by using the environmental information received from the recognition sensor 260. Artificial intelligence (AI) or an image processing processor may be used for recognition.

The posture sensor 270 acquires information related to a posture of the vehicle 1 (hereinafter, also referred to as “posture information”) and outputs the acquired information to the computer 210. The posture sensor 270 includes various sensors that detect the acceleration, the angular velocity, and the position of the vehicle 1. In the present embodiment, the posture sensor 270 includes an inertial measurement unit (IMU) and a global positioning system (GPS) sensor. The IMU detects the acceleration of each of a front-rear direction, a right-left direction, and an up-down direction of the vehicle 1, and the angular velocity of each of a roll direction, a pitch direction, and a yaw direction of the vehicle 1. The GPS sensor detects the position of the vehicle 1 by using signals received from a plurality of GPS satellites. A technique of measuring the posture with high accuracy by combining the IMU and the GPS is known in a field of an automobile and an aircraft. The computer 210 may measure the posture of the vehicle 1 from the posture information described above by using, for example, such a known technique.

The sensor cleaner 290 is a device that removes dirt from the sensor (for example, the recognition sensor 260) that is exposed to the outside air outside the vehicle. For example, the sensor cleaner 290 may be configured to use a cleaning solution and the windshield wiper to clean a lens of the camera and an exit of the obstacle detector.

In the vehicle 1, in order to improve the safety, predetermined functions (for example, braking, steering, and vehicle fixing) are provided with redundancy. A control system 102 of the base vehicle 100 includes a plurality of systems that realizes equivalent functions. Specifically, the brake system 121 includes brake systems 121A, 121B. The steering system 122 includes steering systems 122A, 122B. The powertrain system 123 includes an EPB system 123A and a P-Lock system 123B. Each system includes an ECU. Even in a case where the abnormality occurs in one of the systems that realize the equivalent functions, the other of the systems is operated normally, so that the function works normally in the vehicle 1.

The VCIB 111 includes a VCIB 111A and a VCIB 111B. Each of the VCIBs 111A, 111B includes a computer. The communication modules 210A, 210B of the computer 210 are configured to communicate with the computers of the VCIBs 111A, 111B, respectively. The VCIB 111A and the VCIB 111B are connected to each other to be communicable with each other. Each of the VCIBs 111A, 111B can be operated independently, and even in a case where the abnormality occurs in one of the VCIBs 111A, 111B, the other of the VCIBs 111A, 111B is operated normally, so that the VCIB 111 is operated normally. Both the VCIBs 111A, 111B are connected to each of the systems described above via the integrity control manager 115. It should be noted that, as shown in FIG. 2, connection destinations of the VCIB 111A and the VCIB 111B are partially different.

In the present embodiment, a function of accelerating the vehicle 1 is not provided with redundancy. The powertrain system 123 includes a propulsion system 123C as a system for accelerating the vehicle 1.

The vehicle 1 is configured to switch between the autonomous mode and the manual mode. The API signal received by the ADK 200 from the VCIB 111 includes a signal indicating whether the vehicle 1 is in the autonomous mode or the manual mode (hereinafter, referred to as “autonomous state”). The user can select any of the autonomous mode and the manual mode through a predetermined input device (for example, the HMI 230 or the mobile terminal UT). In a case where any of the driving modes is selected by the user, the vehicle 1 is set to the selected driving mode, and the selection result is reflected in the autonomous state. It should be noted that, in a case where the vehicle 1 is not in a state in which autonomous driving can be executed, the driving mode does not shift to the autonomous mode even when the user selects the autonomous mode. Switching of the driving modes of the vehicle 1 may be executed by the integrity control manager 115. The integrity control manager 115 may switch between the autonomous mode and the manual mode in accordance with a status of the vehicle.

In a case where the vehicle 1 is in the autonomous mode, the computer 210 acquires a state of the vehicle 1 from the VP 2 and sets a next operation of the vehicle 1 (for example, acceleration, deceleration, and turning). Moreover, the computer 210 outputs various commands for realizing the next set operation of the vehicle 1. In a case where the computer 210 executes the API software (that is, the autonomous driving software using the API), the command related to the autonomous driving control is transmitted from the ADK 200 to the integrity control manager 115 through the VCIB 111.

FIG. 3 is a flowchart showing processing executed by the ADK 200 in the autonomous driving control according to the present embodiment. The processing shown in this flowchart is repeatedly executed in a cycle corresponding to the API (API cycle) in a case where the vehicle 1 is in the autonomous mode. In a case where the driving mode of the vehicle 1 is switched from the manual mode to the autonomous mode, a start signal indicating the start of autonomous driving is transmitted from the vehicle 1 (communication device 130) to the server 500 together with the identification information of the vehicle 1, and a series of processing shown in FIG. 3 described below is started. In the following, each step in the flowchart is simply referred to as “S”.

With reference to FIG. 3 together with FIGS. 1 and 2, in S101, the computer 210 acquires the current information of the vehicle 1. For example, the computer 210 acquires the environmental information and the posture information of the vehicle 1 from the recognition sensor 260 and the posture sensor 270. Further, the computer 210 acquires the API signal. In the present embodiment, the API signal indicating the state of the vehicle 1 is sequentially output from the VCIB 111 to the ADK 200 in real time regardless of whether the vehicle 1 is in any of the autonomous mode and the manual mode. In order to improve the accuracy of the autonomous driving control, the state of the vehicle 1 may be sequentially transmitted from the integrity control manager 115 to the ADK 200 in a shorter cycle in the autonomous mode than in the manual mode. The API signal acquired by the computer 210 includes, in addition to the autonomous state described above, signals indicating the rotation direction and the rotation speed of each wheel detected by the wheel speed sensors 127A, 127B.

In S102, the computer 210 creates the traveling plan based on the information of the vehicle 1 acquired in S101. For example, the computer 210 calculates the behavior of the vehicle 1 (for example, the posture of the vehicle 1) and creates the traveling plan suitable for the state of the vehicle 1 and the external environment. The traveling plan is data indicating the behavior of the vehicle 1 in a predetermined period. In a case where the traveling plan is already present, the traveling plan may be amended in S102.

In S103, the computer 210 extracts a controlled physical quantity (acceleration, tire turning angle, or the like) from the traveling plan created in S102. In S104, the computer 210 divides the physical quantity extracted in S103 for each API cycle. In S105, the computer 210 executes the API software by using the physical quantity divided in S104. By executing the API software in this way, the API command (propulsion direction command, propulsion command, braking command, vehicle fixing command, or the like) requesting control to realize the physical quantity in accordance with the traveling plan is transmitted from the ADK 200 to the VCIB 111. The VCIB 111 transmits the control command corresponding to the received API command to the integrity control manager 115, and the integrity control manager 115 executes the autonomous driving control of the vehicle 1 in response to the control command. The state of the vehicle 1 during autonomous driving is sequentially recorded in the storage device of the computer 210.

In following S106, the computer 210 determines whether or not the vehicle 1 is in the autonomous mode. While the autonomous mode is maintained (YES in S106), autonomous driving of the vehicle 1 is executed by repeatedly executing the processing of S101 to S105. On the other hand, in a case where the vehicle 1 is in the manual mode (NO in S106), in S107, an end signal indicating the end of autonomous driving is transmitted from the vehicle 1 (communication device 130) to the server 500 together with the identification information of the vehicle 1, and then the series of processing shown in FIG. 3 ends. In the present embodiment, the computer 210, the VCIB 111, and the integrity control manager 115 cooperate to execute control to cause the vehicle 1 to travel by autonomous driving. The vehicle 1 can be autonomously driven in any of a manned or unmanned state.

The control device 150 is configured to execute autonomous driving of the vehicle 1 for a predetermined period (hereinafter, referred to as “operation period”). During autonomous driving of the vehicle 1, the processing shown in FIG. 3 is executed, and the control device 150 controls various systems (for example, the brake system 121, the steering system 122, the powertrain system 123, the active safety system 125, and the body system 126 shown in FIG. 2) of the vehicle 1 in response to the command from the ADK 200. The vehicle 1 may provide a predetermined service (for example, a physical distribution service or a passenger transportation service) by autonomous driving during the operation period.

In the present embodiment, the server 500 manages a vehicle group including the vehicle 1. In the following, each vehicle managed by the server 500 (vehicle included in the vehicle group described above) is also referred to as “management vehicle”. Each management vehicle has the same configuration as the vehicle 1 described above. That is, each management vehicle has the configurations shown in FIGS. 1, 2, and 4, and is configured to execute autonomous driving by the processing shown in FIG. 3.

The server 500 manages information related to the management vehicle (hereinafter, also referred to as “vehicle information”). The vehicle information of each management vehicle is stored in the storage device 503 of the server 500. Specifically, the identification information (vehicle ID) for identifying the vehicle is applied to each vehicle, and the server 500 manages the vehicle information by distinguishing the vehicle information using the vehicle ID. The vehicle information includes, for example, a status of each management vehicle (for example, whether or not the vehicle is during autonomous driving). In the present embodiment, each management vehicle has the same vehicle model and the same specifications. The storage device 503 stores the vehicle model and specifications common to all the management vehicles. It should be noted that the present disclosure is not limited to this, and the server 500 may manage a plurality of vehicles having different specifications and use these vehicles for a predetermined service. In such a form, the vehicle information stored in the storage device 503 may include the vehicle model and the specifications of each management vehicle.

In the present embodiment, among a plurality of management vehicles, a vehicle that provides a passenger transportation service by autonomous driving (hereinafter, also referred to as “running vehicle”) is included. The running vehicle according to the present embodiment travels to go around a running region on a predetermined route (traveling route). The running vehicle departs from a predetermined departure point and travels by autonomous driving to follow the predetermined traveling route. One time of running is from the departure of the running vehicle from the departure point to the return to the departure point through each point (hereinafter, also referred to as “waypoint”) set on the traveling route. The running vehicle may function as a fixed-route bus, or may execute passenger transportation by ride sharing.

In the present embodiment, the server 500 manages a plurality of running vehicles. A running requirement is set for each running vehicle before the start of running. In the present embodiment, the traveling route (including the departure point), a running start time (departure time), a running end time (time to return to the departure point), and the number of times of running are adopted as the running requirement. In a case where the number of times of running is two or more, the running start time and the running end time for each running are set in the running vehicle.

The server 500 manages the running vehicles separately as a general vehicle and a representative vehicle. One representative vehicle is selected in advance from among the running vehicles. The general vehicle corresponds to the vehicle other than the representative vehicle among the running vehicles. The vehicle information of the representative vehicle stored in the storage device 503 includes component information indicating a state of a predetermined target component (for example, a component A, a component B, a component C, and a component D) mounted on the representative vehicle. The component information indicates a result of a performance inspection of the representative vehicle for each target component. In the performance inspection, whether or not the vehicle has the performance equal to or greater than a predetermined standard by an objective inspection in accordance with a predetermined procedure is checked for each target component (inspection item). Examples of the target component include a propulsion device (for example, the motor), the braking device, the power storage device, the EPB, the P-Lock device, the suspension, and the tire. For the target component that does not have the performance equal to or greater than the standard, a fail determination is made by the performance inspection. The performance inspection may be executed by using inspection equipment (tester). The performance inspection may be an inspection corresponding to a so-called vehicle inspection.

The component information of the representative vehicle is updated each time the performance inspection of the representative vehicle is executed, and the result of the performance inspection is reflected in the component information. The component information in the present embodiment indicates a pass or a fail (normality or abnormality) of each target component. Such component information indicates the target component in which the abnormality has occurred in the representative vehicle (that is, the target component for which a fail determination is made by the performance inspection).

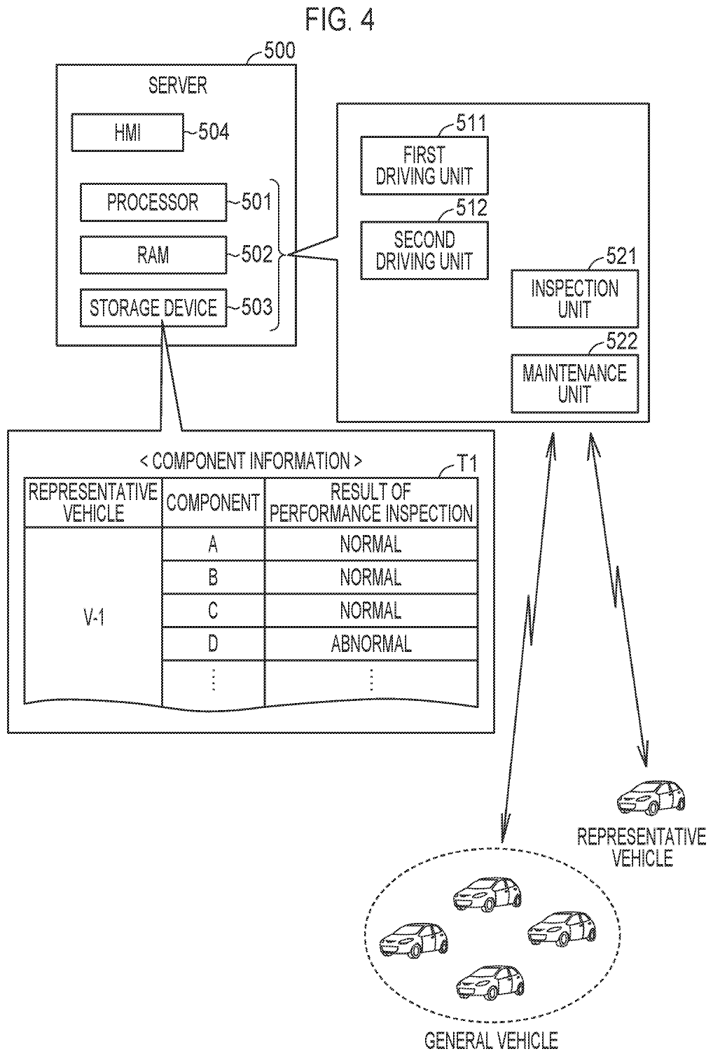

FIG. 4 is a diagram for describing a configuration of the server 500. With reference to FIG. 4 together with FIGS. 1 and 2, the server 500 includes a processor 501, a RAM 502, a storage device 503, and an HMI 504. The server 500 is configured to communicate with each running vehicle. The server 500 may be configured to execute wireless communication with each running vehicle, for example, via a mobile communication network (telematics). The server 500 according to the present embodiment corresponds to an example of a “vehicle management device” according to the present disclosure.

The storage device 503 is configured to store the stored information. The storage device 503 stores information used in a program (for example, a map, a mathematical formula, and various parameters), in addition to the program. A human machine interface (HMI) 504 includes an input device and a display device. The HMI 504 may be a touch panel display. The HMI 504 may include a smart speaker that receives a voice input.

Table T1 in FIG. 4 shows the component information of the representative vehicle stored in the storage device 503. In Table T1, “V-1” corresponds to the vehicle ID of the representative vehicle. Although solely the component information of the representative vehicle (V-1) is shown in FIG. 4, the storage device 503 stores the vehicle information of all the management vehicles registered in the server 500.

The server 500 includes a first driving unit 511, a second driving unit 512, an inspection unit 521, and a maintenance unit 522 described below. In the server 500, each unit is embodied by, for example, the processor 501 and a program executed by the processor 501. It should be noted that the present disclosure is not limited to this, and each of these units may be embodied by dedicated hardware (electronic circuit).

The first driving unit 511 is configured to transmit a first signal for autonomously driving the representative vehicle (first vehicle) under a predetermined first condition. The second driving unit 512 is configured to transmit a second signal for autonomously driving the general vehicle (second vehicle) under a predetermined second condition. The second condition is set such that the vehicle is less likely to be deteriorated than under the first condition. In the present embodiment, the traveling route of autonomous driving is the same in the first condition and the second condition. In the following, the traveling route common to the first condition and the second condition is also referred to as “traveling route Z”. In addition, a traveling purpose of autonomous driving is also the same in the first condition and the second condition. The traveling purpose common to the first condition and the second condition is passenger transportation. On the other hand, a traveling distance in the first condition is set such that the vehicle is more likely to be deteriorated than under the second condition. Specifically, the traveling distance in the first condition is longer than the traveling distance in the second condition. In the present embodiment, the traveling distance in the first condition is twice the traveling distance in the second condition. It should be noted that the present disclosure is not limited to this, and the traveling distance in the first condition may be more than twice and less than 10 times the traveling distance in the second condition, or may be 10 times or more the traveling distance in the second condition.

The inspection unit 521 is configured to make an instruction the performance inspection of the representative vehicle after autonomous driving of the representative vehicle under the first condition ends. The maintenance unit 522 is configured to decide a maintenance time of the general vehicle by using the result of the performance inspection of the representative vehicle.

The server 500 can provide the passenger transportation service by making an instruction for autonomous driving to each running vehicle. In the following, the running vehicles (management vehicles) identified by the vehicle IDs such as “V-1”, “V-2”, “V-3”, “V-4”, and “V-5”, may be simply described as “V-1”, “V-2”, “V-3”, “V-4”, and “V-5”, respectively. In the present embodiment, the V-1 is the representative vehicle, and each of the V-2 to the V-5 is the general vehicle. In the present embodiment, an example will be described in which the passenger transportation service is provided by five running vehicles, but the number of running vehicles can be changed as appropriate. For example, the passenger transportation service may be provided by 10 or more running vehicles.

The server 500 makes the instruction for autonomous driving to the representative vehicle (V-1) under the condition satisfying the running requirement shown below.

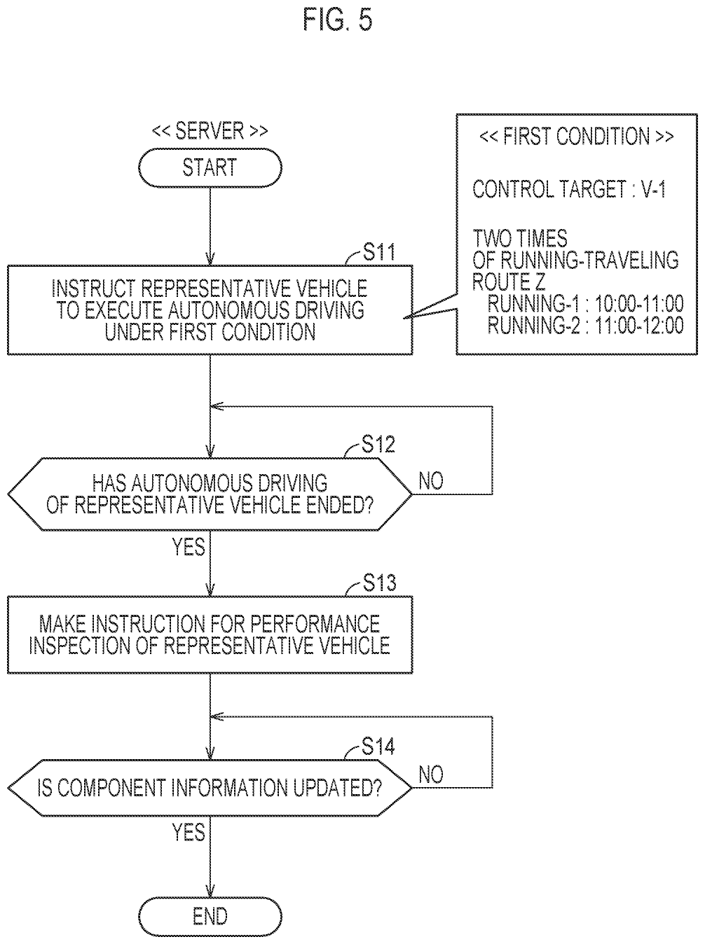

Under the autonomous driving condition for the representative vehicle (V-1), the traveling route is the traveling route Z and the number of times of running is two times/day. Moreover, for first running, the running start time is 10:00 am and the running end time is 11:00 am. For second running, the running start time is 11:00 am and the running end time is 12:00 am. The autonomous driving condition satisfying these running requirement (that is, the autonomous driving condition for the representative vehicle) corresponds to the first condition described above. In addition, in the present embodiment, the server 500 transmits a V-1 running signal indicating the running requirement described above for the V-1 to the V-1 (see S11 in FIG. 5 described below). The V-1 running signal corresponds to the first signal described above.

The server 500 makes the instruction for autonomous driving to each of the general vehicles (V-2 to V-5) under the condition satisfying the running requirement shown below.

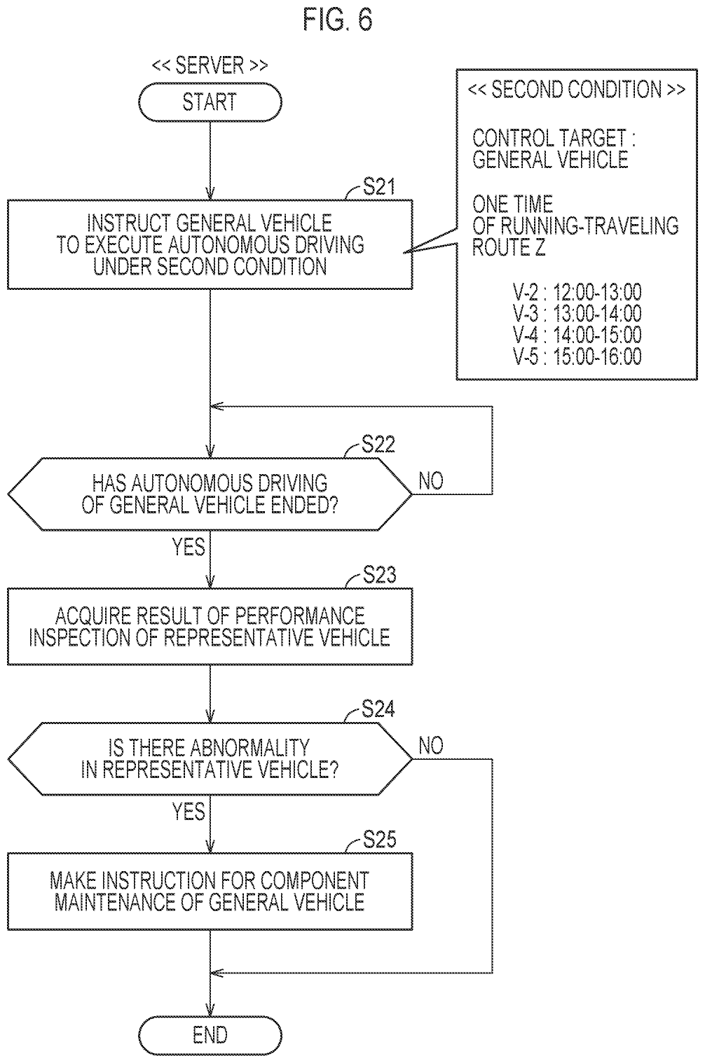

Under the autonomous driving condition for each of the general vehicles (V-2 to V-5), the traveling route is the traveling route Z and the number of times of running is one time/day. Moreover, under the autonomous driving condition for the V-2, the running start time is 12:00 pm and the running end time is 1:00 pm. Under the autonomous driving condition for the V-3, the running start time is 1:00 pm and the running end time is 2:00 pm. Under the autonomous driving condition for the V-4, the running start time is 2:00 pm and the running end time is 3:00 pm. Under the autonomous driving condition for the V-5, the running start time is 3:00 pm and the running end time is 4:00 pm. In the present embodiment, the running start time and the running end time are different for each general vehicle. The autonomous driving condition satisfying these running requirement (that is, the autonomous driving condition for each of the general vehicles) corresponds to the second condition described above. In addition, in the present embodiment, the server 500 transmits a V-2 running signal, a V-3 running signal, a V-4 running signal, and a V-5 running signal indicating the running requirements for the V-2, the V-3, the V-4, and the V-5 to the V-2, the V-3, the V-4, and the V-5, respectively (see S21 in FIG. 6 described below). Each of the V-2 to V-5 running signals corresponds to the second signal described above.

In accordance with the running requirement, each general vehicle runs on the traveling route Z once a day, while the representative vehicle runs on the traveling route Z (the same traveling route as the general vehicle) twice a day. Therefore, the traveling distance of the representative vehicle in one day is twice the traveling distance of each general vehicle in one day. It should be noted that the running requirement is not limited to the above and can be changed as appropriate. For example, the running requirement for each of the first condition and the second condition may further include an arrival time at each waypoint on the traveling route. In the present embodiment, a unit period is set to one day, but a unit period can be changed as appropriate.

FIG. 5 is a flowchart showing management processing executed by the server 500 for the representative vehicle. The processing shown in this flowchart is started before the running start time (10:00 am) set for the representative vehicle (V-1). For example, at a time (for example, 9:30 am) that goes back from the running start time of the representative vehicle by a predetermined time, a series of processing shown in FIG. 5 described below may be started.

With reference to FIG. 5 together with FIGS. 1, 2, and 4, in S11, the first driving unit 511 of the server 500 transmits the first signal to the representative vehicle (V-1). The first signal is the V-1 running signal indicating the running requirement for the representative vehicle (V-1). In a case where the representative vehicle receives the first signal (V-1 running signal), the running requirement indicated by the first signal is set for the representative vehicle, and the driving mode of the representative vehicle is switched from the manual mode to the autonomous mode. As a result, the control device 150 of the representative vehicle starts the series of processing shown in FIG. 3. Moreover, in S102 in FIG. 3, the traveling plan is created to satisfy the running requirement indicated by the first signal. The representative vehicle starts traveling (running) at the running start time, and continues autonomous driving by the processing shown in FIG. 3 until the two times of running indicated by the first signal end. In a case where the two times of running indicated by the first signal are completed, the driving mode of the representative vehicle is switched from the autonomous mode to the manual mode. As a result, autonomous driving of the representative vehicle ends.

In following S12, the first driving unit 511 determines whether or not autonomous driving (autonomous driving under the first condition) of the representative vehicle (V-1) ends. The first driving unit 511 determines that autonomous driving of the representative vehicle ends, for example, in a case where the end signal indicating the end of autonomous driving of the representative vehicle is received. The server 500 waits until autonomous driving of the representative vehicle ends (NO in S12). Moreover, in a case where autonomous driving of the representative vehicle ends (YES in S12), the processing proceeds to S13.

In S13, the inspection unit 521 makes the instruction for the performance inspection of the representative vehicle (V-1). Specifically, the inspection unit 521 transmits a signal (hereinafter, also referred to as “inspection signal”) for making an instruction to undergo the performance inspection to the representative vehicle (V-1). In a case where the representative vehicle receives the inspection signal, the driving mode of the representative vehicle is switched from the manual mode to the autonomous mode, and the series of processing shown in FIG. 3 is started again. By the processing shown in FIG. 3, the representative vehicle travels by autonomous driving toward the inspection place (the place in which the inspection equipment is provided) indicated by the inspection signal. In a case where the representative vehicle arrives at the inspection place, a mechanic executes the performance inspection (inspection of each target component) of the representative vehicle. The server 500 receives input of the result of the inspection. Moreover, in a case where the result of the performance inspection of the representative vehicle is input to the server 500, the server 500 updates the component information (see Table T1 in FIG. 4) of the representative vehicle stored in the storage device 503 based on the result of the performance inspection. After the performance inspection of the representative vehicle is completed, the mechanic may input the result of the performance inspection of the representative vehicle to the server 500 through the HMI 504. For the representative vehicle for which the abnormality has been checked by the performance inspection, needed maintenance (for example, repair or replacement of the component) may be executed by the mechanic.

In following S14, the inspection unit 521 determines whether or not the component information of the representative vehicle is updated based on the result of the performance inspection. The server 500 waits until the component information of the representative vehicle is updated (NO in S14). During waiting, the HMI 504 of the server 500 may give a notification of prompting the input of the result of the performance inspection. Moreover, in a case where the component information of the representative vehicle is updated (YES in S14), the series of processing shown in FIG. 5 ends. In the present embodiment, in a case where the mechanic inputs the result of the performance inspection of the representative vehicle to the server 500, the inspection unit 521 determines YES in S14.

FIG. 6 is a flowchart showing management processing executed by the server 500 for the general vehicle. The processing shown in this flowchart is started for each general vehicle before the running start time (for example, a time that goes back from the running start time by a predetermined time). For example, the processing for the V-2 is started at a time (for example, 11:30 am) that goes back from the running start time (12:00 am) set for the V-2 by a predetermined time. In addition, the processing for the V-3 is started at a time (for example, 12:30 pm) that goes back from the running start time (1:00 pm) set for the V-3 by a predetermined time. In the present embodiment, the processing for the V-3 is started before the running end time (1:00 pm) set for the V-2. That is, during a predetermined period, a series of processing shown in FIG. 6 described below is executed at the same time in parallel for each of the V-2 and the V-3. In addition, after the processing for the V-3 is started, the processing for the V-4 and the V-5 is also sequentially started.

With reference to FIG. 6 together with FIGS. 1, 2 and 4, in S21, the second driving unit 512 of the server 500 transmits the second signal to a target general vehicle (any of the V-2 to the V-5). The second signal differs depending on the target general vehicle. The second signals for the V-2, the V-3, the V-4, and the V-5 are the V-2 running signal, the V-3 running signal, the V-4 running signal, and the V-5 running signal, respectively.

In a case where the target general vehicle receives the second signal (running signal for the general vehicle), the running requirement indicated by the second signal is set for the general vehicle, and the driving mode of the general vehicle is switched from the manual mode to the autonomous mode. As a result, the control device 150 of the general vehicle starts the series of processing shown in FIG. 3. Moreover, in S102 in FIG. 3, the traveling plan is created to satisfy the running requirement indicated by the second signal. The general vehicle continues autonomous driving by the processing shown in FIG. 3 until the one time of running indicated by the second signal ends. In a case where one time of running indicated by the second signal is completed, the driving mode of the general vehicle is switched from the autonomous mode to the manual mode. As a result, autonomous driving of the general vehicle ends.

In following S22, the second driving unit 512 determines whether or not autonomous driving of the general vehicle (autonomous driving under the second condition) ends. The second driving unit 512 determines that autonomous driving of the general vehicle ends, for example, in a case where the end signal indicating the end of autonomous driving of the general vehicle is received. The server 500 waits until autonomous driving of the general vehicle ends (NO in S22). Moreover, in a case where autonomous driving of the general vehicle ends (YES in S22), the processing proceeds to S23.

In S23, the maintenance unit 522 acquires the result of the performance inspection (see S13 and S14 in FIG. 5) of the representative vehicle from the storage device 503. In a case where the performance inspection (S13 in FIG. 5) of the representative vehicle is not completed, the maintenance unit 522 waits. Moreover, in a case where the data is updated after the inspection is completed (YES in S14 in FIG. 5), the maintenance unit 522 acquires the latest data (result of the performance inspection of the representative vehicle) from the storage device 503.

In following S24, the maintenance unit 522 determines whether or not the abnormality (performance degradation exceeding an allowable level) has been checked in any of the components of the representative vehicle by the performance inspection of the representative vehicle. Moreover, in a case where the abnormality has been checked in any of the components of the representative vehicle by the performance inspection of the representative vehicle (YES in S24), in S25, the maintenance unit 522 makes an instruction for the maintenance for the component of the general vehicle corresponding to the component of the representative vehicle in which the abnormality has been checked. For example, in a case where an abnormality of the braking device has been checked in the representative vehicle, the maintenance unit 522 makes an instruction for the maintenance of the braking device of the general vehicle. In response to this instruction, the component maintenance of the general vehicle is executed.

In S25, the maintenance unit 522 transmits, for example, the maintenance signal for requesting the maintenance (for example, inspection, repair, or replacement) of the target component (component for which the abnormality has been checked in the representative vehicle) to the general vehicle of which autonomous driving ends. The control device 150 of the general vehicle that receives the maintenance signal records the arrival of the maintenance time of the target component in the storage device 153 and causes a predetermined notification device (for example, the HMI 230 or the mobile terminal UT) to execute the notification processing of prompting a manager of the general vehicle to execute the maintenance of the target component. In addition, the control device 150 of the general vehicle that receives the maintenance signal may execute processing of moving the general vehicle to a maintenance place by autonomous driving, or may transmit a signal for requesting the maintenance to the terminal of the maintenance company.

In a case where the processing of S25 is executed, a series of processing shown in FIG. 6 ends. By executing the processing of S25, the component maintenance of the general vehicle is executed. On the other hand, in a case where the abnormality has not been checked in any of the components of the representative vehicle by the performance inspection of the representative vehicle (NO in S24), the component maintenance (S25) of the general vehicle is not executed, and the series of processing shown in FIG. 6 ends. In the present embodiment, after autonomous driving of the general vehicle under the second condition ends, the maintenance unit 522 determines whether or not to execute the maintenance of the general vehicle by using the result of the performance inspection on the representative vehicle. That is, the maintenance unit 522 decides the maintenance time of the general vehicle by using the result of the performance inspection of the representative vehicle.

As described above, a vehicle management method according to the first embodiment includes the processing shown in each of FIGS. 3, 5, and 6. In S11 (first autonomous driving step) in FIG. 5, the first vehicle (representative vehicle) included in the vehicle group is autonomously driven under the first condition. In S21 (second autonomous driving step) in FIG. 6, the second vehicle (general vehicle) that is the vehicle other than the first vehicle included in the vehicle group is autonomously driven under the second condition that the vehicle is less likely to be deteriorated than under the first condition. In S13 (performance inspection step) in FIG. 5, after autonomous driving of the first vehicle under the first condition ends (YES in S12 in FIG. 5), the performance inspection of the first vehicle is executed. In S25 (maintenance step) in FIG. 6, the maintenance of the second vehicle is executed in a case where a fail determination is made (YES in S24 in FIG. 6) by the performance inspection of the first vehicle.

In the vehicle management method described above, the maintenance time of the second vehicle is decided by using the result of the performance inspection of the first vehicle. The performance inspection of the first vehicle is executed after the first vehicle is autonomously driven under the condition (first condition) that the vehicle is more likely to be deteriorated than a driving condition (second condition) of the second vehicle. Therefore, in a case where the performance of the first vehicle is determined to be normal by the performance inspection of the first vehicle, it can be estimated that the performance of the second vehicle is also normal. That is, in a case where the performance of the first vehicle is determined to be normal by the performance inspection of the first vehicle, the performance inspection of the second vehicle can be omitted. Therefore, with the vehicle management method described above, it is possible to reduce the total number of performance inspections of each managed autonomous driving vehicle in the system for managing a plurality of autonomous driving vehicles.

### Second Embodiment

A vehicle management device and a vehicle management method according to a second embodiment of the present disclosure will be described. Since the second embodiment has many parts in common with the first embodiment, a difference thereof will be mainly described, and the description of the common parts will be omitted.

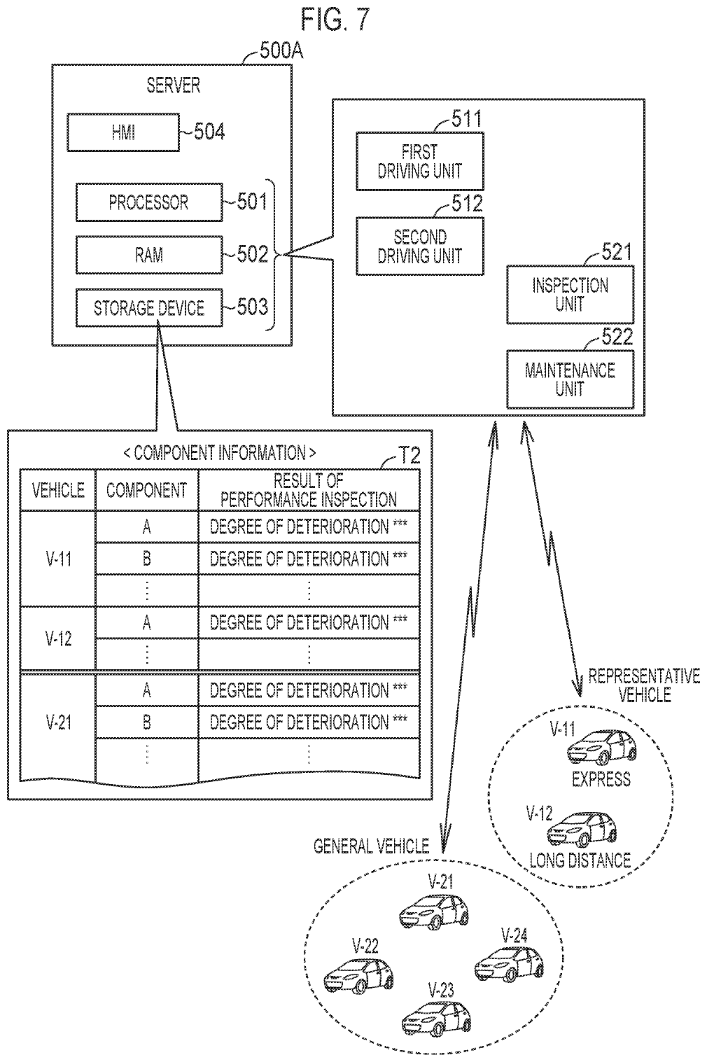

FIG. 7 is a diagram showing a configuration of the vehicle management device according to the second embodiment of the present disclosure. In the second embodiment, a server 500A is adopted instead of the server 500 (FIG. 4) in the first embodiment. In the second embodiment, the server 500A corresponds to an example of the “vehicle management device” according to the present disclosure.

With reference to FIG. 7, similar to the server 500, the server 500A includes the first driving unit 511, the second driving unit 512, the inspection unit 521, and the maintenance unit 522. It should be noted that the maintenance unit 522 of the server 500A is configured to execute an operation for converting the first data indicating the performance of the first vehicle into the second data indicating the performance of the second vehicle. The first vehicle and the second vehicle correspond to the representative vehicle and the general vehicle, respectively.

Although, in the server 500 in the first embodiment, the component information related to the general vehicle is not stored in the storage device 503, the component information related to the general vehicle is also stored in the storage device 503 of the server 500A in the second embodiment, in addition to the component information related to the representative vehicle (see Table T2 in FIG. 7). The component information indicates the state of the predetermined target component (for example, the component A, the component B, . . . ) mounted on the vehicle. The component information related to the representative vehicle includes the first data described above, and the component information related to the general vehicle includes the second data described above. In the present embodiment, a degree of degree of deterioration of the component is adopted as each of the first data and the second data. The component information indicates the degree of deterioration for each target component. The first data is acquired by the performance inspection of the representative vehicle and stored in the storage device 503. Moreover, the maintenance unit 522 of the server 500A executes a predetermined operation and obtains the second data from the first data. The obtained second data is stored in the storage device 503. The maintenance unit 522 of the server 500A may obtain the degree of deterioration (second data) of the component A mounted on the general vehicle as a result of multiplying the degree of deterioration (first data) of the component A mounted on the representative vehicle by the predetermined conversion coefficient. Examples of the component A include the propulsion device (for example, the motor), the braking device, the power storage device, the EPB, the P-Lock device, the suspension, and the tire. In a form in which the specifications differ between the representative vehicle and the general vehicle, the maintenance unit 522 of the server 500A may decide the conversion coefficient by using at least one of the weight of the vehicle body and the air resistance (for example, a value of an air resistance coefficient Cd) of each of the representative vehicle and the general vehicle.

In the second embodiment, V-11 and V-12 are adopted as the representative vehicles instead of the V-1 in the first embodiment. In addition, V-21 to V-24 are adopted as the general vehicles instead of the V-2 to the V-5 in the first embodiment. Under the autonomous driving condition for the V-11, the traveling route is the traveling route Z, the number of times of running is one time/day, the running start time is 9:30 am, and the running end time is 10:00 am. The autonomous driving condition for the V-12 is the same as the autonomous driving condition for the V-1 in the first embodiment. The autonomous driving conditions for the V-21 to the V-24 are the same as the autonomous driving conditions for the V-2 to the V-5 in the first embodiment, respectively.

While each of the general vehicles (V-21 to V-24) runs on the traveling route Z once in one hour, the V-11 runs on the traveling route Z once in 30 minutes. Therefore, the vehicle speed of the V-11 is twice the vehicle speed of each general vehicle.

As described above, the vehicle speed under the autonomous driving condition (first condition) of the V-11 is set such that the vehicle is more likely to be deteriorated than the vehicle speed under the autonomous driving condition (second condition) of each general vehicle. In addition, while each of the general vehicles (V-21 to V-24) runs on the traveling route Z once a day, the V-12 runs on the traveling route Z twice a day. Therefore, the traveling distance of the V-12 in one day is twice the traveling distance of each general vehicle in one day. As described above, the traveling distance under the autonomous driving condition (first condition) of the V-12 is set such that the vehicle is more likely to be deteriorated than the traveling distance under the autonomous driving condition (second condition) of each general vehicle.

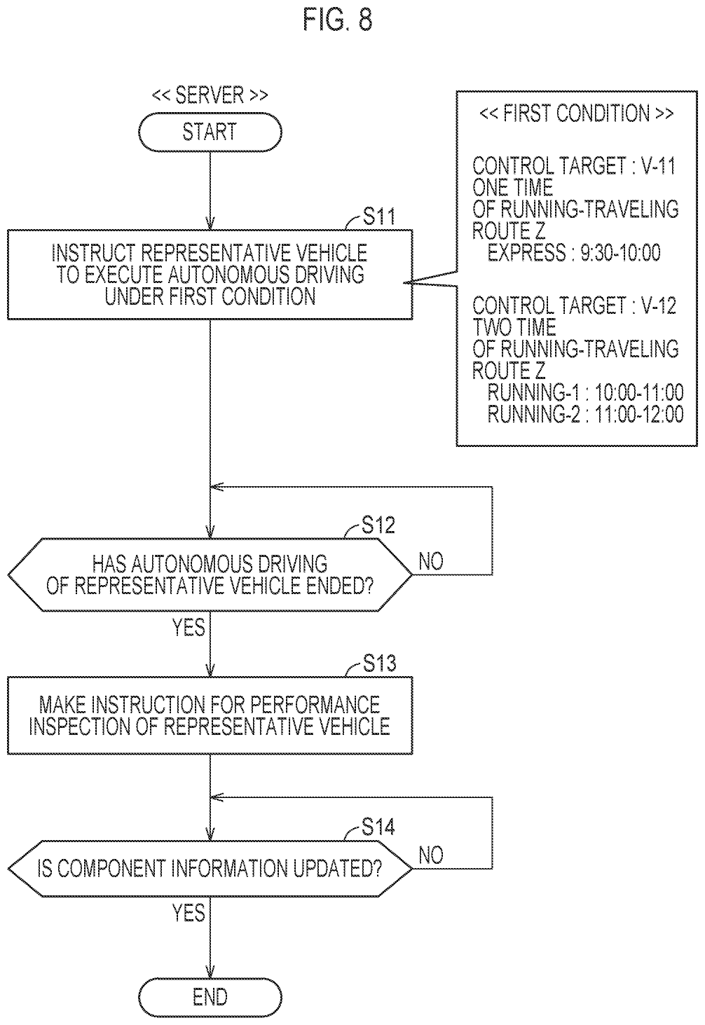

FIG. 8 is a flowchart showing management processing executed by the server 500A for the representative vehicle. The processing shown in the flowchart is executed for each representative vehicle. The processing for the V-11 and the V-12 is sequentially started in accordance with the running start time. A series of processing shown in FIG. 8 is basically a same as the series of processing shown in FIG. 5.

With reference to FIG. 8 together with FIG. 7, in S11, the first driving unit 511 of the server 500A transmits the first signal to a target representative vehicle (V-11 or V-12). The first signal differs depending on the target representative vehicle. The first signal for the V-11 and the V-12 is a V-11 running signal and a V-12 running signal indicating the running requirements for the V-11 and the V-12, respectively. By the processing of S11, the target representative vehicle executes autonomous driving (see FIG. 3) to satisfy the running requirement. Thereafter, the processing of S12 to S14 is executed in the same manner as the processing shown in FIG. 5. It should be noted that, in the performance inspection executed in response to the instruction of S13, the degree of deterioration (first data) of each target component is measured for the target representative vehicle. Moreover, after the performance inspection of the target representative vehicle is completed, the result of the performance inspection of the representative vehicle including the degree of deterioration of each target component is input to the server 500A, and the component information related to the representative vehicle (see Table T2 in FIG. 7) is updated. For the representative vehicle for which the abnormality has been checked by the performance inspection, needed maintenance may be executed by the mechanic.

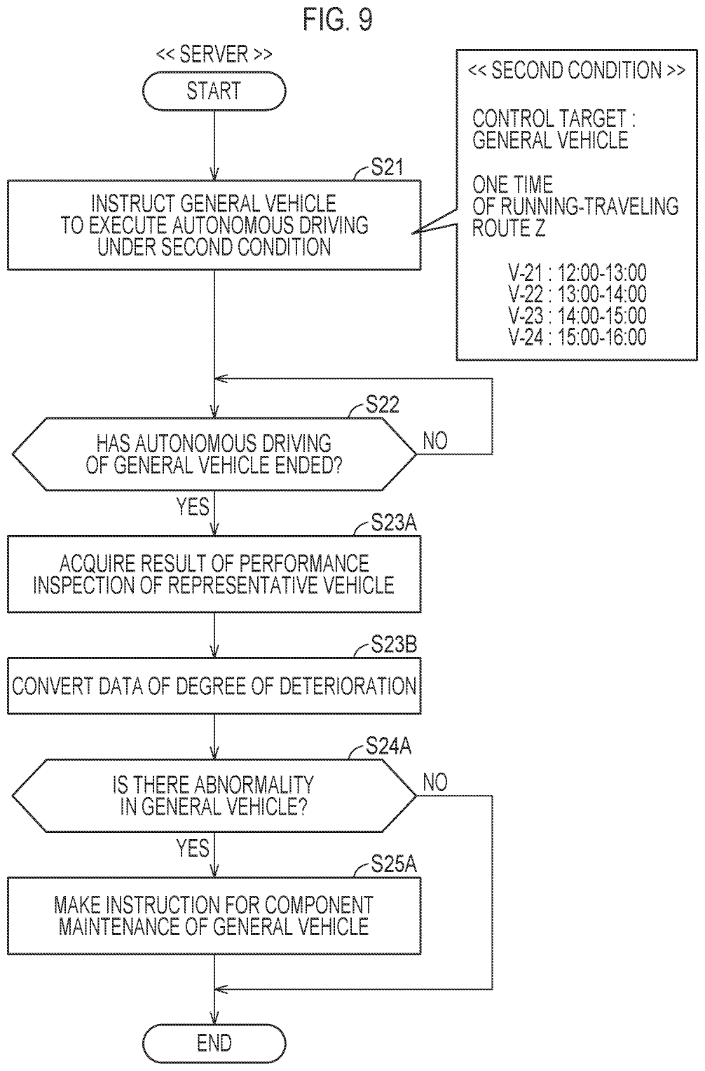

FIG. 9 is a flowchart showing management processing executed by the server 500A for the general vehicle. The processing shown in the flowchart is executed for each general vehicle. The processing for the V-21, the V-22, the V-23, and the V-24 is sequentially started in accordance with the running start time.

With reference to FIG. 9 together with FIG. 7, the processing of S21 and S22 is executed in the same manner as the processing shown in FIG. 6. In following S23A, the maintenance unit 522 of the server 500A acquires the result of the performance inspection (see S13 and S14 in FIG. 8) of the representative vehicle from the storage device 503. Specifically, the maintenance unit 522 of the server 500A acquires the degree of deterioration of the component (degree of deterioration of each target component) of each of the V-11 and the V-12.

In following S23B, the maintenance unit 522 of the server 500A obtains the degree of deterioration of the component of the target general vehicle (any of the V-21 to the V-24) from the degree of deterioration of the component of each of the V-11 and the V-12. Specifically, the maintenance unit 522 of the server 500A obtains the degree of deterioration of the component of the target general vehicle by multiplying an average value of the degrees of deterioration of the components measured for the V-11 and the V-12 by the predetermined conversion coefficient. The conversion coefficient may be common to all the general vehicles or may be different for each general vehicle. The degree of deterioration of the component of the general vehicle is calculated for each target component. The conversion coefficient may be common to all the target components or may be different for each target component. In the present embodiment, an average value of the first data (degree of deterioration of the component) measured for a plurality of representative vehicles is converted into the second data (degree of deterioration of the component) indicating the performance of the general vehicle. However, the present disclosure is not limited to this, and the first data measured for one representative vehicle may be converted into the second data by the predetermined conversion coefficient.

In following S24A, the maintenance unit 522 of the server 500A determines whether or not the abnormality (performance degradation exceeding the allowable level) occurs in any of the components of the target general vehicle. Specifically, the maintenance unit 522 determines whether or not a current degree of deterioration (second data) exceeds a predetermined threshold value for each target component mounted on the general vehicle. The threshold value can be optionally set for each target component. In a case where the degree of deterioration of at least one target component exceeds the threshold value, the maintenance unit 522 determines YES in S24A, and the processing proceeds to S25A.

In S25A, the maintenance unit 522 of the server 500A makes the instruction for the maintenance of the target component of the general vehicle in which the abnormality occurs. In response to the instruction of S25A, the component maintenance of the general vehicle is executed. In the present embodiment, after autonomous driving of the general vehicle under the second condition ends, the maintenance unit 522 calculates the second data indicating the performance of the general vehicle by using the first data indicating the performance of the representative vehicle, and determines whether or not to execute the maintenance of the general vehicle based on the second data. That is, the maintenance unit 522 decides the maintenance time of the general vehicle based on the second data.

As described above, the vehicle management method according to the second embodiment includes the processing shown in each of FIGS. 3, 8, and 9. In S11 (first autonomous driving step) in FIG. 8, the first vehicle (representative vehicle) included in the vehicle group is autonomously driven under the first condition. In S21 (second autonomous driving step) in FIG. 9, the second vehicle (general vehicle) that is the vehicle other than the first vehicle included in the vehicle group is autonomously driven under the second condition that the vehicle is less likely to be deteriorated than under the first condition. In S13 (performance inspection step) in FIG. 8, the performance inspection of the first vehicle is executed to acquire first data indicating performance of the first vehicle after autonomous driving of the first vehicle under the first condition ends. In S23A and S23B (conversion step) in FIG. 9, the first data is converted into the second data indicating the performance of the second vehicle. In S25A (maintenance step) in FIG. 9, in a case where the second data indicates the performance fail of the second vehicle (YES in S24A in FIG. 9), the maintenance of the second vehicle is executed. Even with such a vehicle management method described above, it is possible to reduce the total number of performance inspections of each managed autonomous driving vehicle in the system for managing the autonomous driving vehicles. In addition, in the second embodiment, by adopting the first vehicle, it is easy to appropriately evaluate the performance of the second vehicle by using the result of the performance inspection of each first vehicle.

### Third Embodiment

A vehicle management device and a vehicle management method according to a third embodiment of the present disclosure will be described. Since the third embodiment has many parts in common with the first embodiment, a difference thereof will be mainly described, and the description of the common parts will be omitted.

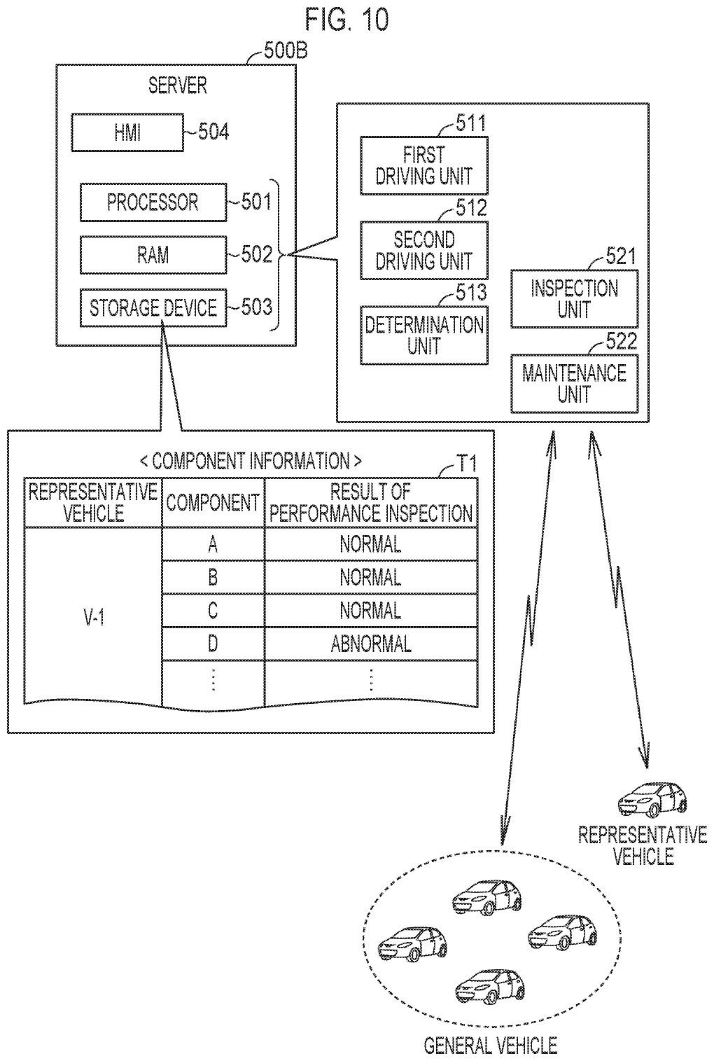

FIG. 10 is a diagram showing a configuration of the vehicle management device according to the third embodiment of the present disclosure. In the third embodiment, a server 500B is adopted instead of the server 500 (FIG. 4) in the first embodiment. In the third embodiment, the server 500B corresponds to an example of the “vehicle management device” according to the present disclosure.

With reference to FIG. 10, the server 500B further includes a determination unit 513 in addition to the first driving unit 511, the second driving unit 512, the inspection unit 521, and the maintenance unit 522. In the server 500B, each unit is embodied by, for example, the processor 501 and the program executed by the processor 501. It should be noted that the present disclosure is not limited to this, and each of these units may be embodied by dedicated hardware (electronic circuit).

The vehicle (management vehicle) managed by the server 500B according to the third embodiment also functions as the running vehicle. It should be noted that the running vehicle according to the third embodiment decides a route in response to each request, and executes traveling by autonomous driving in accordance with the decided route (on-demand route). The running vehicle may function as a robotaxi. A predetermined number of management vehicles are determined in advance as the representative vehicles. Moreover, a management vehicle other than the representative vehicle are used as the general vehicles.

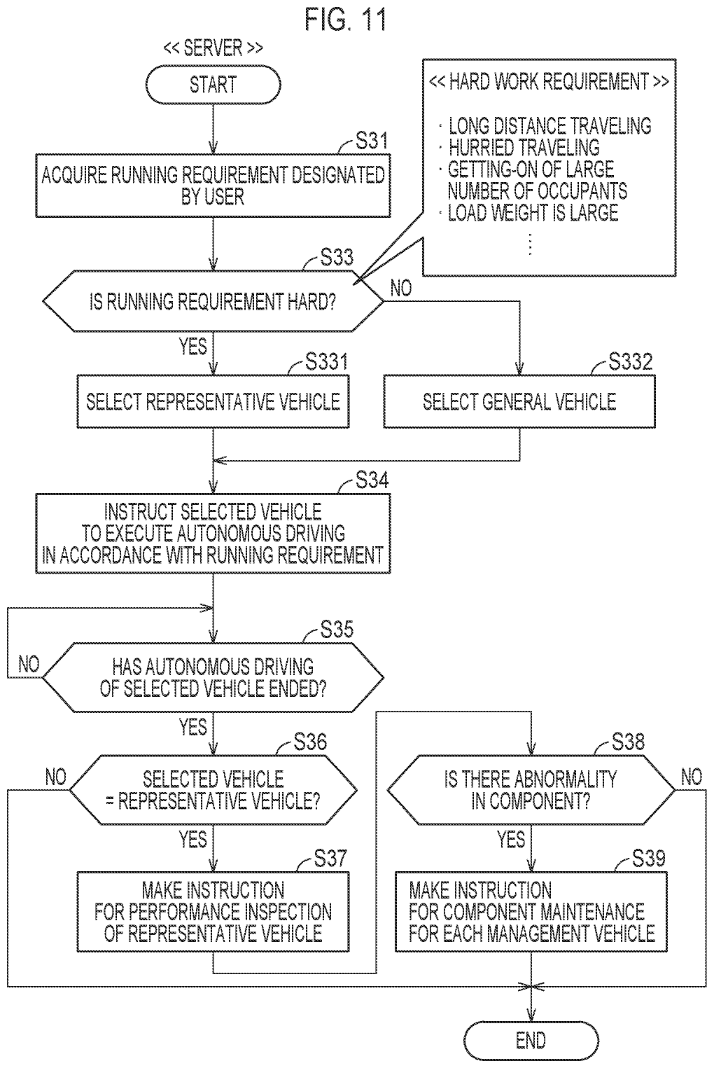

The server 500B acquires the running requirement designated by the user, and instructs the management vehicle (running vehicle) to execute autonomous driving in accordance with the running requirement (requested autonomous driving condition). The determination unit 513 is configured to determine whether the requested autonomous driving condition corresponds to the first condition or the second condition. The details of this determination processing will be described below (see S32 in FIG. 11).

FIG. 11 is a flowchart showing management processing executed by the server 500B for the running vehicle. The processing shown in this flowchart is started in a case where the server 500B receives a running request from the terminal of the user (for example, the mobile terminal of a service user or the vehicle manager).

With reference to FIG. 11 together with FIG. 10, in S31, the determination unit 513 of the server 500B acquires the running requirement designated by the user. The running requirement designated by the user is included in the running request described above.

In following S32, the determination unit 513 determines whether or not the running requirement acquired in S31 is hard. Specifically, the determination unit 513 determines whether or not the running requirement is hard by using at least one of the traveling distance, the weight, and the vehicle speed indicated by the running requirement. The determination unit 513 may determine whether or not the running requirement is hard based on whether or not the traveling distance indicated by the running requirement (for example, the distance from a getting-on position of the user to a destination) is equal to or greater than a predetermined value. The determination unit 513 may determine whether or not the running requirement is hard based on whether or not the number of occupants indicated by the running requirement is equal to or greater than a predetermined value. The determination unit 513 may determine whether or not the running requirement is hard based on whether or not load weight indicated by the running requirement is equal to or greater than a predetermined value. The determination unit 513 may determine whether or not the running requirement is hard based on whether or not the vehicle speed indicated by the running requirement is equal to or greater than a predetermined value. For example, in a case where an express is requested by the running requirement, the determination unit 513 may determine that the running requirement is hard. It should be noted that the requirement (hard work requirement) for which the running requirement is recognized to be hard can be optionally set. For example, the determination unit 513 may determine whether or not the running requirement is hard based on the traveling route indicated by the running requirement. In a case where the traveling route includes a rough road, or in a case where the traveling route includes a steep slope, the determination unit 513 may determine that the running requirement is hard.

In a case where the running requirement is hard (YES in S32), the determination unit 513 selects the representative vehicle from among the management vehicles in an available state in S331. In a case where the representative vehicles are in the available state, the representative vehicle having a low usage frequency (low degree of deterioration) is preferentially selected. A YES determination in S32 means that the requested autonomous driving condition corresponds to the first condition.

In a case where the running requirement is not hard (NO in S32), the determination unit 513 selects the general vehicle from among the management vehicles in the available state in S332. In a case where a plurality of general vehicles is in the available state, the general vehicle having a low usage frequency (low degree of deterioration) is preferentially selected. A NO determination in S32 means that the requested autonomous driving condition corresponds to the second condition.

In the following, the vehicle (representative vehicle or general vehicle) selected in S331 or S332 will be referred to as “selected vehicle”. In following S34, the server 500B instructs the selected vehicle to execute autonomous driving satisfying the running requirement acquired in S31. Specifically, in a case where the selected vehicle is the representative vehicle, the first driving unit 511 of the server 500B transmits the first signal for autonomously driving the selected vehicle under the first condition (condition satisfying the hard work requirement) to the selected vehicle. In a case where the selected vehicle is the general vehicle, the second driving unit 512 of the server 500B transmits the second signal for autonomously driving the selected vehicle under the second condition (condition that does not satisfy the hard work requirement) to the selected vehicle.

The processing of S34 corresponds to the processing of S11 in FIG. 5. By the processing of S34, autonomous driving (see FIG. 3) is executed such that the selected vehicle satisfies the running requirement. In following S35, the server 500B determines whether or not autonomous driving of the selected vehicle ends. In a case where autonomous driving of the selected vehicle ends (YES in S35), the inspection unit 521 of the server 500B determines in S36 whether or not the selected vehicle is the representative vehicle. In a case where the selected vehicle is the representative vehicle (YES in S36), the inspection unit 521 makes the instruction for the performance inspection of the representative vehicle in S37. The processing of S37 corresponds to the processing of S13 in FIG. 5. In response to the instruction of S37, the performance inspection (inspection of each target component) of the representative vehicle is executed.

In following S38, the maintenance unit 522 of the server 500B determines whether or not the abnormality (performance degradation exceeding an allowable level) has been checked in any of the components of the representative vehicle by the performance inspection of the representative vehicle. The processing of S38 corresponds to the processing of S24 in FIG. 6. In a case where the abnormality has been checked in any of the components of the representative vehicle by the performance inspection of the representative vehicle (YES in S38), in S39, the maintenance unit 522 makes the instruction for the component maintenance for all of the representative vehicle and the general vehicles included in the vehicle group (all the management vehicles). The component that is the target of the maintenance is the component in which the abnormality has been checked in the representative vehicle. The maintenance processing corresponds to the processing of S25 in FIG. 6.

In a case where the processing of S39 is executed, a series of processing shown in FIG. 11 ends. By executing the processing of S39, the component maintenance of each management vehicle is executed. On the other hand, in a case where abnormality has not been checked in any of the components of the representative vehicle by the performance inspection of the representative vehicle (NO in S38), the component maintenance (S39) is not executed, and the series of processing shown in FIG. 11 ends. In addition, in a case where the selected vehicle is the general vehicle (NO in S36), neither the performance inspection (S37) nor the component maintenance (S39) is executed, and the series of processing shown in FIG. 11 ends.

As described above, the vehicle management method according to the third embodiment includes the processing shown in each of FIGS. 3 and 11. In the processing shown in FIG. 11, in S32, a determination is made as to whether the autonomous driving condition designated by the user corresponds to the first condition or the second condition. In a case where the autonomous driving condition corresponds to the first condition (YES in S32), in S34, the first vehicle (representative vehicle) included in the vehicle group is autonomously driven under the first condition. On the other hand, in a case where the autonomous driving condition corresponds to the second condition (NO in S32), in S34, the second vehicle (general vehicle) that is the vehicle other than the first vehicle included in the vehicle group is autonomously driven under the second condition that the vehicle is less likely to be deteriorated than under the first condition. In S37 in FIG. 11, the performance inspection of the first vehicle is executed after autonomous driving of the first vehicle under the first condition ends. In S39 in FIG. 11, in a case where a fail determination is made by the performance inspection of the first vehicle (YES in S38 in FIG. 11), the maintenance of each of the first vehicle and the second vehicle is executed. Even with such a vehicle management method described above, it is possible to reduce the total number of performance inspections of each managed autonomous driving vehicle in the system for managing the autonomous driving vehicles. In addition, each of the first vehicle and the second vehicle can be appropriately operated in accordance with the requested autonomous driving condition.

### Another Embodiment

The function of the server according to each of the embodiments described above may be provided on the cloud by cloud computing. A level of autonomous driving may be fully autonomous driving (level 5) or conditional autonomous driving (for example, level 4). The traveling purpose of autonomous driving under each of the first condition and the second condition is not limited to the passenger transportation and can be changed as appropriate. For example, the traveling purpose of autonomous driving may be a mobile office, a physical distribution, or a medical care.

The configuration of the vehicle is not limited to the configuration described in each of the embodiments described above (see FIGS. 1 and 2). The base vehicle may have an autonomous driving function without retrofitting. The configuration of the vehicle may be changed to a configuration dedicated to unmanned traveling, as appropriate. For example, a vehicle dedicated to unmanned traveling does not have to include the component (steering wheel or the like) for a person to operate the vehicle. The vehicle may include a solar panel or may have a flight function. The vehicle is not limited to a passenger car, and may be a bus or a truck. The vehicle may be a privately owned vehicle (POV). The vehicle may be a multipurpose vehicle customized in accordance with the user's purpose of use. The vehicle may be a mobile store vehicle, an automated guided vehicle (AGV), or an agricultural machine. The vehicle may be an unmanned or one-passenger small BEV (for example, a Micro Pallet).

Each embodiment and each modification example described above may be carried out in any combination.

The embodiment disclosed this time should be considered to be exemplary examples and not to be restrictive in all respects. The technical scope of the present disclosure is shown by the scope of claims rather than the description of the embodiment described above, and is intended to include all changes within the meaning and scope equivalent to the scope of claims.

What is claimed is:

1. A vehicle management device comprising:
a first driving unit configured to transmit a first signal for autonomously driving a first vehicle included in a vehicle group under a first condition;
a second driving unit configured to transmit a second signal for autonomously driving a second vehicle that is a vehicle other than the first vehicle included in the vehicle group under a second condition that the vehicle is less likely to be deteriorated than under the first condition;
an inspection unit configured to make an instruction for a performance inspection of the first vehicle after autonomous driving of the first vehicle under the first condition ends; and
a maintenance unit configured to decide a maintenance time of the second vehicle by using a result of the performance inspection of the first vehicle.

2. The vehicle management device according to claim 1, wherein the maintenance unit is configured to determine whether or not to execute maintenance of the second vehicle by using the result of the performance inspection of the first vehicle after autonomous driving of the second vehicle under the second condition ends.

3. The vehicle management device according to claim 1, wherein a traveling route of autonomous driving is the same in the first condition and the second condition.

4. The vehicle management device according to claim 1, wherein a traveling purpose of autonomous driving is the same in the first condition and the second condition.

5. The vehicle management device according to claim 1, wherein at least one of a traveling distance, weight, and a vehicle speed in the first condition is set such that the vehicle is more likely to be deteriorated than under the second condition.

6. The vehicle management device according to claim 1, wherein:
the result of the performance inspection of the first vehicle includes first data indicating performance of the first vehicle; and
the maintenance unit is configured to execute an operation of converting the first data into second data indicating performance of the second vehicle and decide the maintenance time of the second vehicle based on the second data.

7. The vehicle management device according to claim 1, further comprising a determination unit configured to determine whether or not a requested autonomous driving condition corresponds to any of the first condition and the second condition, wherein:
the first driving unit is configured to transmit the first signal in a case where the requested autonomous driving condition corresponds to the first condition; and
the second driving unit is configured to transmit the second signal in a case where the requested autonomous driving condition corresponds to the second condition.

8. A vehicle management method comprising:
autonomously driving a first vehicle under a first condition;
autonomously driving a second vehicle under a second condition that a vehicle is less likely to be deteriorated than under the first condition;
executing a performance inspection of the first vehicle after autonomous driving of the first vehicle under the first condition ends; and
executing maintenance of the second vehicle in a case where a fail determination is made by the performance inspection of the first vehicle.

9. The vehicle management method according to claim 8, further comprising determining whether or not an autonomous driving condition designated by a user corresponds to any of the first condition and the second condition, wherein:
autonomous driving of the first vehicle is executed under the first condition in a case where the autonomous driving condition corresponds to the first condition; and
autonomous driving of the second vehicle is executed under the second condition in a case where the autonomous driving condition corresponds to the second condition.

10. The vehicle management method according to claim 8, wherein a traveling route of autonomous driving is the same in the first condition and the second condition.

11. The vehicle management method according to claim 8, wherein a traveling purpose of autonomous driving is the same in the first condition and the second condition.

12. The vehicle management method according to claim 8, wherein at least one of a traveling distance, weight, and a vehicle speed in the first condition is set such that the vehicle is more likely to be deteriorated than under the second condition.

13. A vehicle management method comprising:
autonomously driving a first vehicle under a first condition;
autonomously driving a second vehicle under a second condition that a vehicle is less likely to be deteriorated than under the first condition;
executing a performance inspection of the first vehicle to acquire first data indicating performance of the first vehicle after autonomous driving of the first vehicle under the first condition ends;
converting the first data into second data indicating performance of the second vehicle; and
executing maintenance of the second vehicle in a case where the second data indicates a performance fail of the second vehicle.

14. The vehicle management method according to claim 13, wherein a traveling route of autonomous driving is the same in the first condition and the second condition.

15. The vehicle management method according to claim 13, wherein a traveling purpose of autonomous driving is the same in the first condition and the second condition.

16. The vehicle management method according to claim 13 wherein at least one of a traveling distance, weight, and a vehicle speed in the first condition is set such that the vehicle is more likely to be deteriorated than under the second condition.
